(19) United States
(12) Patent Application Publication
(10) Pub. No.: US 2026/0073591 A1
(43) Pub. Date: Mar. 12, 2026

(54) LIGHTNESS MODELS FOR IMAGE VISUAL ENHANCEMENT

(71) Applicant: Samsung Electronics Co., Ltd., Suwon-si (KR)

(72) Inventor: Yingen Xiong, Mountain View, CA (US)

(21) Appl. No.: 19/173,247

(22) Filed: Apr. 8, 2025

Related U.S. Application Data
(60) Provisional application No. 63/691,793, filed on Sep. 6, 2024.

(51) Int. Cl. G06T 11/60; G06T 7/70; G06V 10/60; H04N 9/73

(52) U.S. Cl. CPC G06T 11/60; G06T 7/70; G06V 10/60; H04N 9/73; G06T 2207/30168

(57) ABSTRACT

A method includes obtaining an image frame using at least one imaging sensor. The method also includes selecting one of a plurality of lightness models based on visual quality of the image frame, applying the selected lightness model to the image frame in order to generate a modified image frame, and rendering an image for display based on the modified image frame. The visual quality is associated with a lightness condition of the image frame. Different lightness models are associated with different lightness conditions.

### CROSS-REFERENCE TO RELATED APPLICATION AND PRIORITY CLAIM

This application claims priority under 35 U.S.C. § 119(e) to U.S. Provisional Patent Application No. 63/691,793 filed on Sep. 6, 2024, which is hereby incorporated by reference in its entirety.

### TECHNICAL FIELD

This disclosure relates generally to image processing systems and processes. More specifically, this disclosure relates to lightness models for image visual enhancement.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to lightness models for image visual enhancement.

In a first embodiment, an apparatus includes at least one imaging sensor configured to capture an image frame. The apparatus also includes at least one processing device configured to select one of a plurality of lightness models based on visual quality of the image frame, apply the selected lightness model to the image frame in order to generate a modified image frame, and render an image for display based on the modified image frame. The visual quality is associated with a lightness condition of the image frame. Different lightness models are associated with different lightness conditions.

In a second embodiment, a method includes obtaining an image frame using at least one imaging sensor. The method also includes selecting one of a plurality of lightness models based on visual quality of the image frame, applying the selected lightness model to the image frame in order to generate a modified image frame, and rendering an image for display based on the modified image frame. The visual quality is associated with a lightness condition of the image frame. Different lightness models are associated with different lightness conditions.

In a third embodiment, a non-transitory machine readable medium contains instructions that when executed cause at least one processor of an electronic device to obtain an image frame using at least one imaging sensor. The non-transitory machine readable medium also contains instructions that when executed cause the at least one processor to select one of a plurality of lightness models based on visual quality of the image frame, apply the selected lightness model to the image frame in order to generate a modified image frame, and render an image for display based on the modified image frame. The visual quality is associated with a lightness condition of the image frame. Different lightness models are associated with different lightness conditions.

Any one or any combination of the following features may be used with the first, second, or third embodiment. The lightness models may be generated by (i) determining one or more thresholds to define the different lightness conditions and (ii) for each of the defined lightness conditions, capturing multiple image frames at the defined lightness condition; creating a dataset for the defined lightness condition based on the multiple image frames captured at the defined lightness condition; and generating the lightness model for the defined lightness condition with one or more parameters based on the dataset. One of the plurality of lightness models may be selected by measuring a signal-to-noise ratio (SNR) and lightness level of the image frame; determining whether the measured lightness level falls outside a lightness level threshold; determining whether the measured SNR is greater than an SNR threshold; and in response to the measured SNR being less than the SNR threshold, selecting the lightness model having parameters matching the measured SNR and measured lightness level of the image frame. In response to a determination that the measured SNR is greater than the SNR threshold, at least one of a white balance algorithm, a histogram equalization algorithm, an image re-lighting algorithm, or a lightness adjustment algorithm may be selected for application to the image frame. A transformation may be applied to the modified image frame in order to generate a transformed image frame, and the transformed image frame may be rendered in order to render the image for display. A dataset may be generated using the image frame, and a specified one of the lightness models may be updated using the dataset. The updated specified lightness model may be applied to the image frame in order to generate the modified image frame. The image frame may include a first image frame, a second image frame may be captured sequentially with the first image frame, and a difference between user head poses associated with the first and second image frames may be obtained. In response to a determination that the difference is not greater than the head pose change threshold, whether visual quality of the second image frame falls outside one or more thresholds may be determined utilizing an SNR and lightness level of the first image frame. In response to a determination that the difference is greater than the head pose change threshold, whether the visual quality of the second image frame falls outside the one or more thresholds may be determined utilizing an SNR and lightness level of the second image frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for image visual enhancement for extended reality (XR) or other applications in accordance with this disclosure;

FIGS. 3A through 3C illustrate example functions in the process of FIG. 2 in accordance with this disclosure;

FIG. 4 illustrates an example technique for lightness condition model generation for image visual enhancement in XR or other applications in accordance with this disclosure;

FIG. 5 illustrates an example technique for visual enhancement of an image frame in accordance with this disclosure;

FIG. 6 illustrates an example technique for selecting a lightness models based on image frame parameters in accordance with this disclosure; and

FIG. 7 illustrates an example method for image visual enhancement for XR or other applications in accordance with this disclosure.

### DETAILED DESCRIPTION

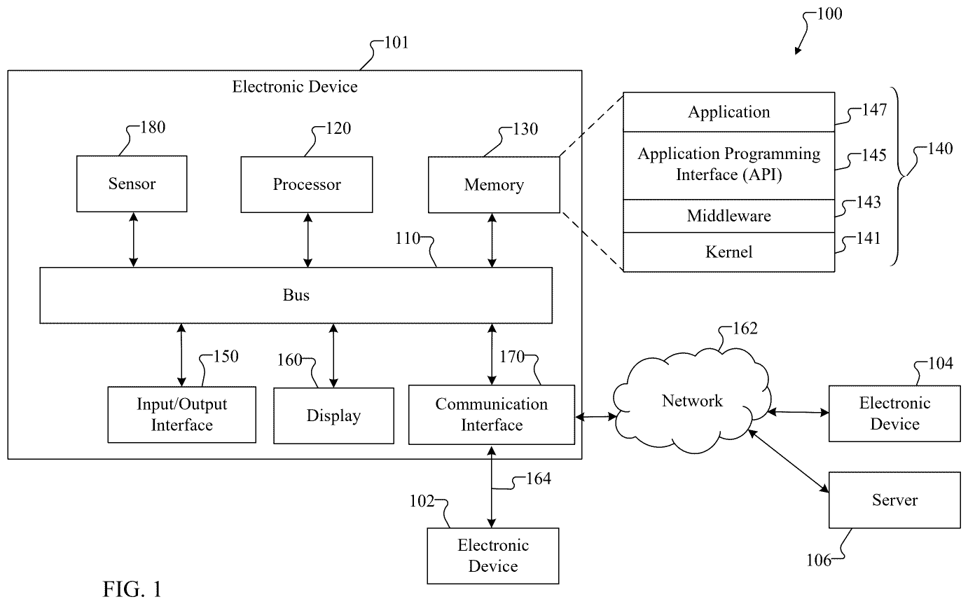

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. One problem is that the image quality of the captured image frames can be affected by conditions in the surrounding environment and properties of the imaging sensors themselves. For example, when inadequate lighting is available in the user's surrounding environment, captured image frames can appear dark and noisy, which makes it difficult for the user to discern content in the captured environment and can even cause user discomfort. Some visual enhancement approaches require generating a frame from multiple captured image frames with different exposures. However, these approaches may not be feasible in VST XR scenarios or other scenarios in which multiple image frames with different exposures may not be available.

This disclosure provides various techniques supporting for image visual enhancement for XR or other applications. As described in more detail below, an image frame can be obtained using at least one imaging sensor. One of a plurality of lightness models can be selected based on visual quality of the image frame, and the visual quality may be associated with a lightness condition of the image frame. Different lightness models may be associated with different lightness conditions. The lightness conditions may be defined based on one or more thresholds (such as a normal lightness condition threshold). The selected lightness model can be applied to the image frame in order to generate a modified image frame, and an image for display can be rendered based on the modified image frame. To create each of the lightness models, multiple image frames at a defined lightness condition may be captured, and a dataset for the defined lightness condition may be created based on the multiple image frames captured at the defined lightness condition. A lightness model for the defined lightness condition may be generated with one or more parameters, such as a signal-to-noise ratio (SNR), a brightness and contrast of the lightness condition of the image frames captured, etc.

In this way, the disclosed techniques can be used to provide visual enhancement of an image without having to generate a visually-enhanced image using multiple image frames captured with different exposures. For example, the disclosed techniques can be used to build different lightness models offline corresponding to different lightness conditions (such as for indoor and outdoor environments). Thus, the image parameters of each captured image frame may be matched to the lightness condition parameters of the already-generated lightness models, and the visual quality of the image frame may be enhanced using the selected lightness model based on the matching. As a result, this can significantly improve user experience, even in low-light environments. Moreover, both lightness models and response models may be applied to image frames in order to generate modified image frames, where each response model defines a mapping of scene irradiance to image brightness or intensity based on the imaging sensor (thereby adding further refinement for the modification).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to image visual enhancement for XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform image visual enhancement for XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to image visual enhancement for XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

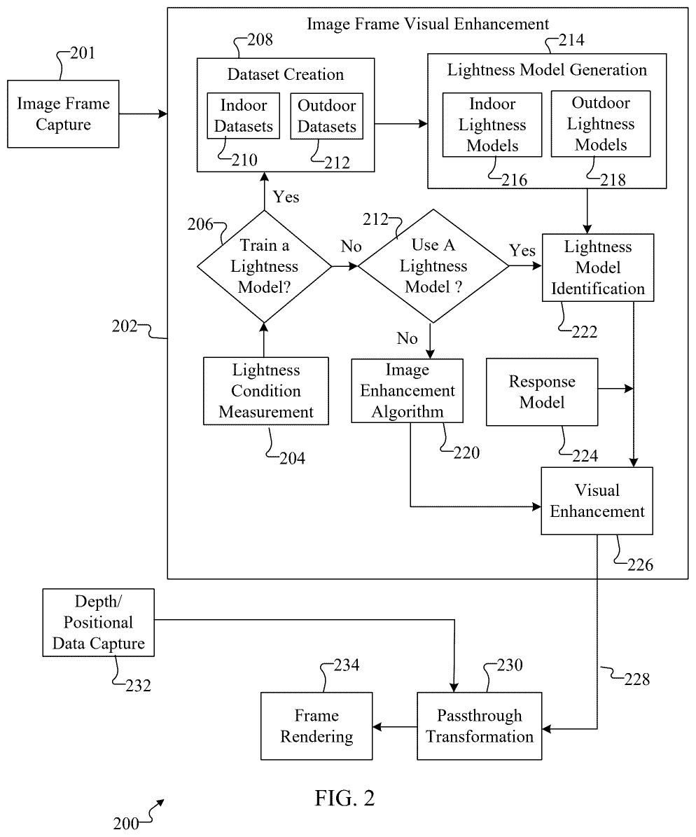

FIG. 2 illustrates an example process 200 for image visual enhancement for XR or other applications in accordance with this disclosure. For ease of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s).

As shown in FIG. 2, the process 200 includes an image frame capture operation 201. The image frame capture operation 201 generally operates to obtain an image frame captured by the electronic device 101, such as an image frame captured using one or more imaging sensors 180 of the electronic device 101. The captured image frame may represent an image frame of a scene captured by a forward-facing or other imaging sensor(s) 180 of the electronic device 101. In some cases, the image frame may represent a high-resolution color image frame. Any suitable pre-processing of the captured image frame may be performed here.

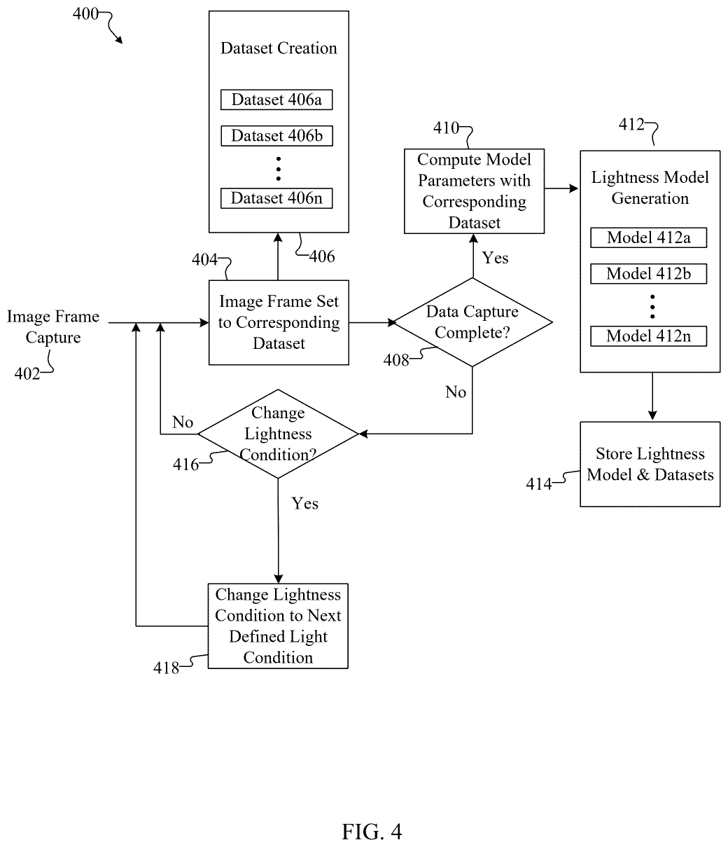

An image frame visual enhancement operation 202 generally operates to process and visually enhance the image frame obtained by the image frame capture operation 201. For example, a lightness condition measurement function 204 generally operates to measure the lightness condition, such as image brightness and intensity as well as SNR, of the image frame. A lightness model training determination function 206 generally operates to allow the user to determine whether to train (or update) a specified lightness model from a plurality of existing lightness models based on the lightness condition measurement. In some cases, the lightness models may be fully calibrated at manufacturing of the electronic device 101 and generated based on corresponding datasets, and the lightness model training determination function 206 may allow those lightness models to be updated over time. These functions are discussed in further detail below with reference to FIG. 4.

The user may request to train/update a specified lightness model based on the measured lightness condition if the user determines that the measured lightness condition is the same as or substantially similar to the parameters of the specified lightness model. Upon such request, a dataset generation operation 208 may create or update a dataset corresponding to the specified lightness model with the measured lightness condition. After creating or updating the corresponding dataset, a lightness model generation operation 214 may update the specified lightness model based on the corresponding dataset. Thus, only a partial update to an existing model and dataset may be needed, even if an image frame includes a lightness condition that may differ from the stored datasets.

If the user does not request to train or update a specified lightness model, a lightness model use determination operation 212 generally operates to determine whether to use an existing lightness model based on one or more thresholds. If it is determined not to use an existing lightness model, an image enhancement algorithm selection operation 220 can be used to select another image enhancement algorithm, such as a histogram equalization algorithm, an image re-lighting algorithm, or a brightness and contrast adjustment algorithm, to perform visual enhancement during a visual enhancement operation 226.

If it is determined to use a lightness model, a lightness model identification operation 218 can be used to identify a lightness model corresponding to the measured lightness condition of the image frame in order to perform the visual enhancement operation 226. For example, if the SNR of the image frame is greater than an SNR threshold and the measured lightness condition is outside of a lightness condition threshold (such as a normal lightness condition threshold), the image enhancement algorithm selection operation 220 may be triggered. If the SNR of the image frame is less than the SNR threshold and the lightness condition is outside of the lightness condition threshold, the lightness model identification operation 222 may be performed. Upon selection of a lightness model, a response model operation 224 may be performed in conjunction with the application of the selected lightness model to the image frame for the visual enhancement operation 226. In some cases, the response model operation 224 may be performed by using an existing response model, which may be built offline with the datasets captured by a see-through camera or other imaging sensor 180.

A passthrough transformation operation 230 generally operates to apply one or more transformations to an enhanced image frame 228 produced by the visual enhancement operation 226 in order to generate a transformed image frame. For example, the passthrough transformation operation 230 may be used to compensate for things like registration and parallax errors, which may be caused by factors like differences between the positions of the imaging sensor(s) 180 and the user's eyes. As particular examples, the passthrough transformation operation 230 may apply a rotation and/or a translation to the enhanced image frame 228 in order to compensate for these or other types of issues. Ideally, the transformations give the appearance that the images presented to the user are captured at the locations of the user's eyes, when the image frames in reality are captured at one or more different locations. Often times, the rotation and/or translation can be derived mathematically based on the position and angle of each imaging sensor 180 and the expected or actual positions of the user's eyes. In some cases, the transformations are static (since these positions and angles will not change), allowing passthrough transformations to be applied quickly.

A depth and positional data capture operation 232 generally operates to obtain information related to the depth of an object within the captured image frame and the pose of the user's head while the electronic device 101 is being used, which may be used by the passthrough transformation operation 230. The depth data may be obtained from any suitable source(s), such as from one or more depth sensors like at least one time-of-flight (ToF) sensor, light detection and ranging sensor (LiDAR), or stereo vision sensor. The head pose information may also be obtained from any suitable source(s), such as from one or more positional sensors like at least one IMU. In some cases, the head pose information may be expressed using six degrees of freedom, such as three translation values and three rotation values. The three translation values may identify movement of the user's head along three orthogonal axes, and the three rotation values may identify rotation of the user's head about the three orthogonal axes. Note, however, that the head pose information may have any other suitable form.

A frame rendering operation 234 generally operates to create final views of the scene captured in the transformed image frames generated by the passthrough transformation operation 230. The frame rendering operation 234 can also render the final views for presentation to a user of the electronic device 101. For example, the frame rendering operation 230 may process the transformed image frames and perform any additional refinements or modifications needed or desired, and the resulting images can represent the final views of the scene. For instance, a 3D-to-2D warping can be used to warp the final views of the scene into 2D images. The frame rendering operation 234 can also present the rendered images to the user. For example, the frame rendering operation 234 can render the images into a form suitable for transmission to at least one display 160 and can initiate display of the rendered images, such as by providing the rendered images to one or more displays 160. In some cases, there may be a single display 160 on which the rendered images are presented for viewing by the user, such as where each eye of the user views a different portion of the display 160. In other cases, there may be separate displays 160 on which the rendered images are presented for viewing by the user, such as one display 160 for each of the user's eyes.

Although FIG. 2 illustrates one example of a process 200 for image visual enhancement for XR or other applications, various changes may be made to FIG. 2. For example, various components or functions in FIG. 2 may be combined, further subdivided, replicated, omitted, or rearranged and additional components or functions may be added according to particular needs. Also, while the process 200 is described as involving the processing of an image frame, the process 200 may be duplicated or repeated in order to process one or more sequences of image frames, such as a sequence of image frames from each of left and right see-through cameras or other stereo imaging sensors 180.

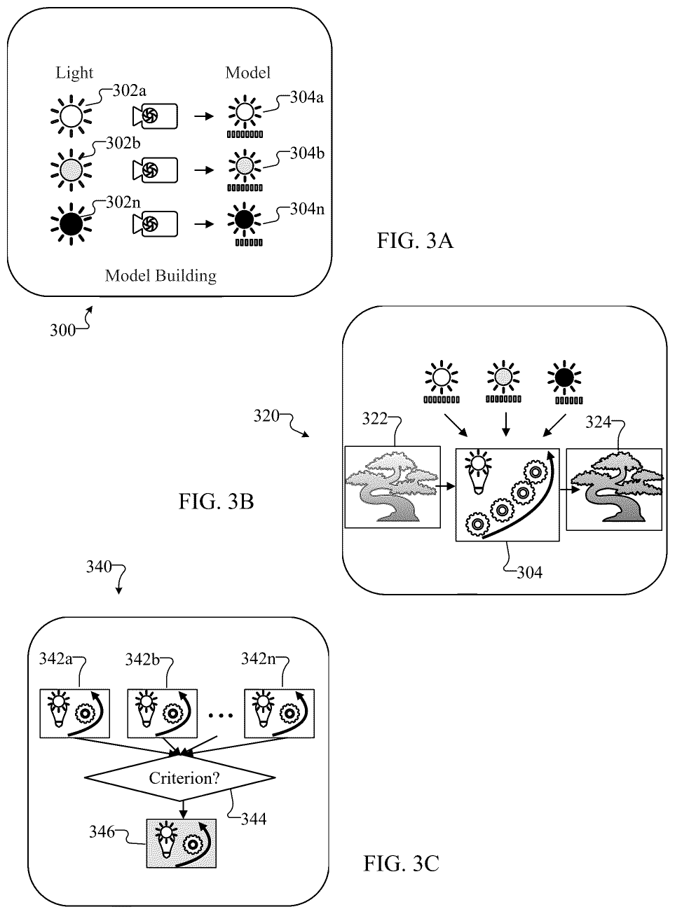

FIGS. 3A through 3C illustrate example functions in the process 200 of FIG. 2 in accordance with this disclosure. As shown in FIG. 3A, one operation associated with the process 200 is an offline lightness model generation operation 300, which may occur at the manufacturer of the electronic device 101 or at any other suitable time(s). During the operation 300, the electronic device 101 can process multiple image frames captured at different lightness conditions 302a-302n and generate one or more lightness models 304a-304n based on the corresponding lightness conditions 302a-302n using the image frames. For example, each lightness model 304 may be associated with image frames captured in one defined lightness condition.

As shown in FIG. 3B, another operation that may be associated with the process 200 is an image frame visual enhancement operation 320, which may occur as part of the visual enhancement operation 226. During the operation 320, the electronic device 101 can apply a lightness model 304 associated with an image frame 322 captured in a corresponding lightness condition 302. This leads to the generation of an enhanced image frame 324, which represents an improved version of the image frame 322. Thus, the image frame visual enhancement operation 320 adaptively enhances image visibility in accordance with the lightness conditions in which the image frame 322 is captured and allows dynamic measurements of the lightness conditions of the image frame 322 based on the SNR and image properties thereof.

As shown in FIG. 3C, yet another operation that may be associated with the process 200 is a best-fit lightness model selection operation 340, which may occur as part of the lightness model identification operation 218. During the operation 340, the electronic device 101 can compare the measured lightness condition of an image frame being processed to a criterion 344 (such as a low-light criterion) to determine whether the image frame represents a low-light image frame. In some embodiments, the criterion is based on the lightness condition (brightness and intensity) B(μ, σ) and the SNR value SNR of the image frame. As a particular example, a low-light criterion C may be used to determine whether each image frame represents a low-light image frame as follows:

$$C = \{ \begin{matrix}B ( μ , σ ) < B and SNR < S if I ( x , y ) is a low - light image \\ Other\end{matrix}$$

Here, B is a threshold of the low-light image value for the image frame, and S is a threshold of the SNR for the image frame.

If it is determined that the image frame is a low-light image frame, a best-fit lightness model 346 may be selected from the multiple lightness models 342a-342n for visual enhancement of the image frame based on the measured lightness condition and SNR. Thus, the electronic device 101 may dynamically provide a bet-fit visual enhancement approach according to the measured lightness condition of the image frame.

Although FIGS. 3A through 3C illustrate examples of functions in the process 200 shown in FIG. 2, various changes may be made to FIGS. 3A through 3C. For example, any suitable number of image frames captured in any lightness condition(s) 302a-302n may be created and made available for use in processing image frames.

FIG. 4 illustrates an example technique 400 for lightness condition model generation for image visual enhancement in XR or other applications in accordance with this disclosure. For ease of explanation, the technique 400 shown in FIG. 4 is described as being implemented using the electronic device 101 in the network configuration 100 shown in FIG. 1, where the electronic device 101 may implement the process 200 shown in FIG. 2. However, the technique 400 may be implemented using any other suitable device(s) and in any other suitable system(s), and the technique 400 may be used to implement any other suitable process(es) designed in accordance with this disclosure.

To generate lightness models 412a-412n, one or more thresholds may be determined to define different lightness conditions. For each of the defined lightness conditions, the electronic device 101 may capture multiple image frames 402 at the defined lightness condition. An image frame setting operation 404 generally sets each captured image frame to a corresponding dataset. A dataset creation operation 406 generally creates a dataset 406 for each defined lightness condition based on the multiple image frames captured at the defined lightness condition.

The datasets 406 may be created for different light environments, such as datasets captured in one or more indoor environments and datasets captured in one or more outdoor environments. In some cases, the indoor datasets may be created based on see-through color image frames with different indoor light conditions, such as low-light, normal light, and strong light conditions. The outdoor datasets may be created based on see-through color image frames with different outdoor light conditions, such as low-light, normal light, and strong light conditions. The see-through image frames may undergo post-processing to create corresponding indoor datasets and outdoor datasets.

The indoor lightness models may be generated based on the indoor datasets. For example, a low-light indoor lightness model, a normal-light indoor lightness model, and a strong-light indoor lightness model may be generated based on a low-light indoor dataset, a normal-light indoor dataset, and a strong-light indoor dataset, respectively. Similarly, the outdoor lightness models may be generated based on the outdoor datasets. For example, a low-light outdoor lightness model, a normal-light outdoor lightness model and a strong-light outdoor lightness model may be generated based on a low-light outdoor dataset, a normal-light outdoor dataset, and a strong-light outdoor dataset, respectively.

It will be understood that these are for illustrative purposes only and that more or fewer lightness models may be generated based on corresponding datasets. For example, a series of low-light indoor lightness models may be generated based on a corresponding series of low-light indoor datasets, such as a first low-light indoor lightness model generated based on a corresponding first low-light indoor dataset, a second low-light indoor lightness model generated based on a corresponding second low-light indoor dataset that represents a lower indoor lightness condition than the first low-light indoor dataset, etc. Similarly, a series of strong-light indoor lightness models may be generated based on a corresponding series of strong-light indoor dataset, such as a first strong-light indoor lightness model generated based on a corresponding first strong-light indoor dataset, a second strong-light indoor lightness model generated based on a corresponding second strong-light indoor dataset that represents a stronger indoor lightness condition than the first strong-light indoor dataset, etc.

A series of low-light outdoor lightness models may be generated based on a corresponding series of low-light outdoor dataset, such as a first low-light outdoor lightness model generated based on a corresponding first low-light outdoor dataset, a second low-light outdoor lightness model generated based on a corresponding second low-light outdoor dataset that represents a lower outdoor lightness condition than the first low-light outdoor dataset, etc. Similarly, a series of strong-light outdoor lightness models may be generated based on a corresponding series of strong-light outdoor dataset, such as a first strong-light outdoor lightness model generated based on a corresponding first strong-light outdoor dataset, a second strong-light outdoor lightness model generated based on a corresponding second strong-light outdoor dataset that represents a stronger outdoor lightness condition than the first strong-light outdoor dataset, etc.

A data capture complete determination operation 408 generally determines whether the data capture for all of the defined lightness conditions is complete. If the data capture is not complete, a change lightness condition operation 416 generally operates to change a lightness condition of the image capturing environment to a next defined lightness condition(s) for which the data capture is incomplete. The electronic device 101 captures multiple image frames for the next defined lightness conditions, and the image frames are set to the dataset corresponding to the next defined lightness conditions until the data capture for all of the defined lightness conditions is complete.

If the data capture is complete, a model parameter compute operation 410 generally computes model parameters with the corresponding datasets. For example, the model parameter compute operation 410 may compute the standard deviation and mean pixel values of each image frame for the corresponding dataset as follows:

$$\{ \begin{matrix}μ = \frac{1}{N} {\sum }_{i = 1}^{N} {I}_{c} ( i , j ) ) \\ {σ}^{2} = \frac{1}{N} {\sum }_{i = 1}^{N} I ( {{p}_{i} ( x , y )}^{2} - {μ}^{2} )\end{matrix}$$

Here, N represents the number of the pixels in the image frame, μ represents the mean pixel value in the image frame, σ represents the standard deviation of the pixel values in the image frame, and pᵢ(x, y)∈N represents each pixel in the image frame. In addition, the model parameter compute operation 410 may compute the SNR of each image frame for the corresponding dataset as follows:

$$SNR = 10 {log}_{10}^{( \frac{{P}_{signal}}{{P}_{noise}} )}$$

Here, P_{signal} is a pixel signal (which could equal μ), and Pₙₒᵢₛₑ is a noise signal (which could equal σ).

A lightness model generation operation 412 generally operates to generate lightness models for corresponding defined lightness conditions based on parameters computed with the corresponding datasets 406a-406n. In some cases, the lightness models may be generated as follows.

$$\{ \begin{matrix}{BTF}_{model 412 a} ( parameters , ( {SNR}_{model 412 a} , ( {μ}_{model 412 a} , {σ}_{model 412 a} ) ) from Dataset 406 a \\ {BTF}_{model 412 b} ( parameters , ( {SNR}_{model 412 b} , ( {μ}_{model 412 b} , {σ}_{model 412 b} ) ) from Dataset 406 b \\ … \\ {BTF}_{model \_ 412 n} ( parameters , ( {SNR}_{model \_ 412 n} , ( {μ}_{model \_ 412 n} , {σ}_{model \_ 412 n} ) ) from Dataset 406 n\end{matrix}$$

A storage operation 414 generally operates to store the generated lightness models and datasets within the electronic device 101 or a remote storage. The stored lightness models 412a-412n may subsequently be used in the visual enhancement of image frames in VST XR or other applications.

Although FIG. 4 illustrates one example of a technique 400 for lightness condition model generation for image visual enhancement in XR or other applications, various changes may be made to FIG. 4. For example, various components, operations, or functions in FIG. 4 may be combined, further subdivided, replicated, omitted, or rearranged and additional components, operations, or functions may be added according to particular needs. Also, FIG. 4 represents one example implementation of the lightness model generation operation 400, and other approaches may be used to generate lightness models 412. As a particular example, a machine learning model may be trained to process multiple image frames for each defined lightness condition and generate a lightness model 412. This may allow, for instance, the machine learning model to be trained in an offline manner and to be applied in an online manner.

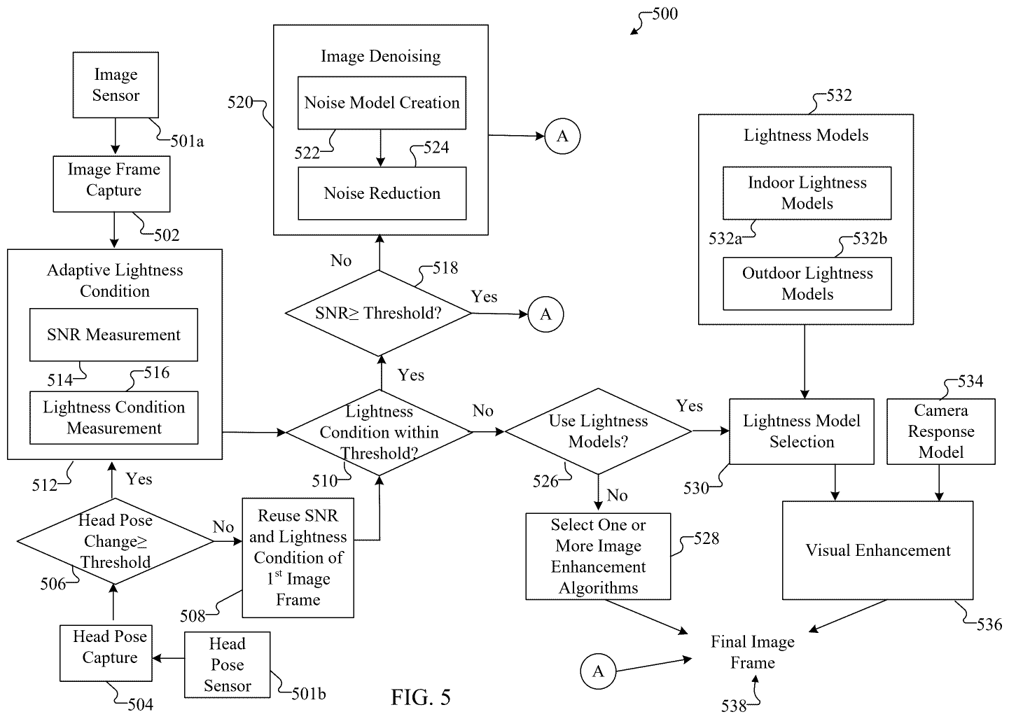

FIG. 5 illustrates an example technique 500 for visual enhancement of an image frame in accordance with this disclosure. The technique 500 may, for example, be used as part of the visual enhancement operation 202 in the process 200 shown in FIG. 2. For ease of explanation, the technique 500 shown in FIG. 5 is described as being implemented using the electronic device 101 in the network configuration 100 shown in FIG. 1, where the electronic device 101 may implement the process 200 shown in FIG. 2. However, the technique 500 may be implemented using any other suitable device(s) and in any other suitable system(s), and the technique 500 may be used to implement any other suitable process(es) or architecture(s) designed in accordance with this disclosure.

As shown in FIG. 5, the technique 500 is used in conjunction with one or more imaging sensors 501a and one or more position sensors 501b, which may represent various sensors 180 of the electronic device 101. The one or more imaging sensors 501a provide an image frame, and the one or more position sensors 501b can provide user head pose data. An image frame capture function 502 can be used to provide the image frame to a lightness condition measurement function 512. A head pose capture function 504 can be used to provide user head pose data captured in the image frame to a head pose determination function 506.

The head pose determination function 506 can be used to determine whether a difference between user head poses associated with the image frame and a previous image frame captured sequentially with the image frame is greater than or equal to a head pose threshold. In many cases, for instance, an image frame will be captured at one time, a rendered image will be subsequently displayed to the user some amount of time later, and it is possible for the user to move his or her head during this intervening time period. The head pose determination function 506 can be used to determine if the user's head pose changes by at least a threshold amount. In response to a determination that the difference is not greater than the head pose change threshold, a reuse function 508 can be used to reuse the SNR and lightness condition of a previous image frame for visual enhancement and/or noise reduction of the current image frame. In response to a determination that the difference is greater than the head pose change threshold, a lightness condition measurement function 512 can be used to measure the SNR 514 and lightness condition 516 of the image frame.

A lightness condition threshold determination function 510 can be used to determine whether the lightness condition of the image frame falls within a lightness condition threshold. In response to a determination that the lightness condition is within a lightness condition threshold (such as a normal lightness condition threshold), a determination function 518 can be used to determine whether the SNR of the image frame (or the previous image frame if the SNR thereof is being reused) is greater than or equal to an SNR threshold. In response to a determination that the SNR of the image frame is less than the SNR threshold, an image denoising function 520 can be used to create a noise model 522 and reduce noise 524 using the noise model. Upon image denoising, an image frame generation function 538 can be used to generate a final modified image frame for passthrough transformation and rendering. In response to a determination that the SNR of the image frame is greater than or equal to the SNR threshold, the image frame generation function 538 can be used to generate a final modified image frame for passthrough transformation and rendering.

In response to a determination that the lightness condition falls outside of the lightness condition threshold, a model use determination function 526 can be used to determine whether a lightness model should be used for visual enhancement of the image frame. In response to a determination that a lightness model should not be used, an image enhancement algorithm selection function 528 can be used to select one or more image enhancement algorithms, such as a histogram equalization algorithm, an image re-lighting algorithm, or a lightness adjustment algorithm, for application to the image frame. After visual enhancement by the one or more selected image enhancement algorithms, the image frame generation function 538 may generate a final modified image frame for passthrough transformation and rendering.

In response to a determination that a lightness model should be used, a model section function 530 can be used to select a lightness model 532 with parameters corresponding to the image parameters (such as the SNR and the lightness condition) of the image frame. In conjunction with the selected lightness model 532, a response function 534 can be used to apply a response model for the visual enhancement of the image frame. In some examples, both the lightness model 532 and the response model can be obtained by a manufacture calibration of the electronic device 101. In some examples, where a pixel is significantly bright and causes an image compression, the bright pixel may be treated as noise and replaced with an average value of neighboring pixels. A visual enhancement function 536 can be used to provide the visual enhancement using the selected lightness model 532 and the camera response model. After visual enhancement based on the lightness and response models, the image frame generation function 538 can be used to generate a final modified image frame for passthrough transformation and rendering. In other examples, the response model may not be used in conjunction with the selected lightness model.

Although FIG. 5 illustrates one example of a technique 500 for visual enhancement of an image frame, various changes may be made to FIG. 5. For example, various components, operations, or functions in FIG. 5 may be combined, further subdivided, replicated, omitted, or rearranged and additional components, operations, or functions may be added according to particular needs. Also, while the technique 500 is described as processing an image frame, the technique 500 may be duplicated or repeatedly used in order to process one or more sequences of image frames, such as a sequence of image frames from each of left and right see-through cameras or other stereo imaging sensors 180.

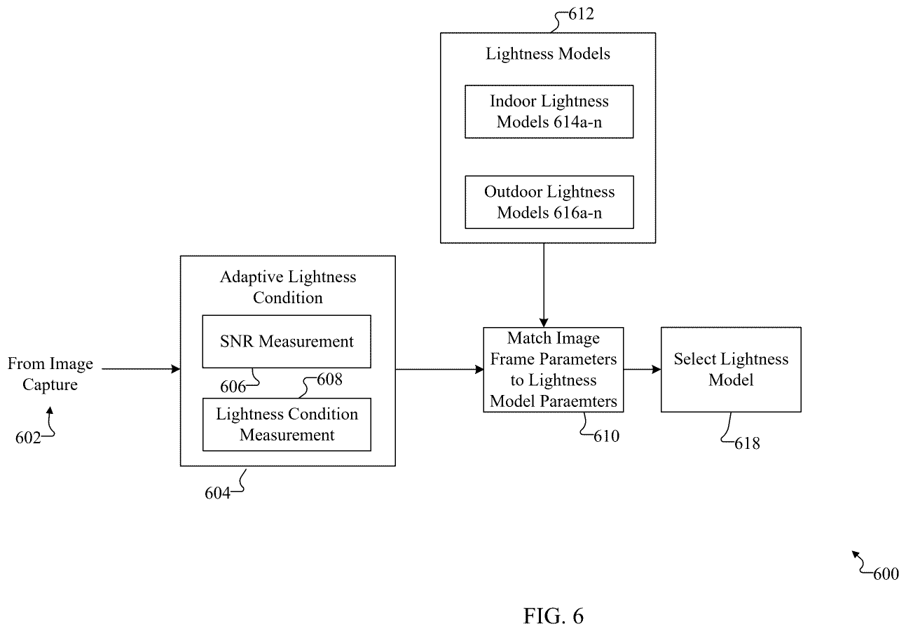

FIG. 6 illustrates an example technique 600 for selecting a lightness model based on image frame parameters in accordance with this disclosure. For ease of explanation, the technique 600 shown in FIG. 6 is described as being implemented using the electronic device 101 in the network configuration 100 shown in FIG. 1, where the electronic device 101 may implement the process 200 shown in FIG. 2. However, the technique 600 may be implemented using any other suitable device(s) and in any other suitable system(s), and the technique 600 may be used to implement any other suitable process(es) or architecture(s) designed in accordance with this disclosure.

As shown in FIG. 6, an image frame 602 is obtained using a see-through camera or other imaging sensor 180 and used as an input for determining a best-fit lightness model for visually enhancing the image frame 602. An adaptive lightness condition function 604 can be used to measure adaptive lightness condition, such as the SNR_{frame} 606 and the lightness condition B(μ, σ) 608 of the image frame 602. Here, μ is the mean and σ is the standard deviation of the image data in at least part of the image frame 602, and SNR_{frame} is the signal-to-noise ratio of the image data in at least part of the image frame 602.

The lightness models 612 may include various models, such as indoor lightness models 614 and outdoor lightness models 616 as follows. In some cases, these models may be defined as follows.

$$\begin{matrix}Indoor \{ \begin{matrix}{BFT}_{model 614 a} ( parameters , ( {SNR}_{model 614 a} , ( {μ}_{model 614 a} , {σ}_{model 614 a} ) ) \\ {BFT}_{model 614 b} ( parameters , ( {SNR}_{model 614 b} , ( {μ}_{model 614 a} , {σ}_{model 614 b} ) ) \\ … \\ {BFT}_{model 614 n} ( parameters , ( {SNR}_{model 614 n} , ( {μ}_{model 614 a} , {σ}_{model 614 n} ) )\end{matrix} \\ Outdoor \{ \begin{matrix}{BFT}_{model 615 a} ( parameters , ( {SNR}_{model 616 a} , ( {μ}_{model 616 a} , {σ}_{model 616 a} ) ) \\ {BFT}_{model 616 b} ( parameters , ( {SNR}_{model 616 b} , ( {μ}_{model 616 a} , {σ}_{model 616 b} ) ) \\ … \\ {BFT}_{model 616 n} ( parameters , ( {SNR}_{model 616 n} , ( {μ}_{model 616 a} , {σ}_{model 616 n} ) )\end{matrix}\end{matrix}$$

A matching function 610 can be used to match the measured lightness condition to lightness model parameters in order to select a best-fit lightness model for visually enhancing the image frame 602. In some cases, for example, the matching function 610 may operate as follows.

$$( {SNR}_{frame} , B ( {μ}_{frame} , {σ}_{frame} ) ) ⇔ ( {SNR}_{model} , BFT ( {μ}_{model} , {σ}_{model} ) )$$

A model selection function 618 can be used to select the best-fit lightness model based on the matching to perform the visual enhancement of the image frame 602.

Although FIG. 6 illustrates one example of a technique 600 for a best-fit lightness model selection for visual enhancement of an image frame, various changes may be made to FIG. 6. For example, various components, operations, or functions in FIG. 6 may be combined, further subdivided, replicated, omitted, or rearranged and additional components, operations, or functions may be added according to particular needs.

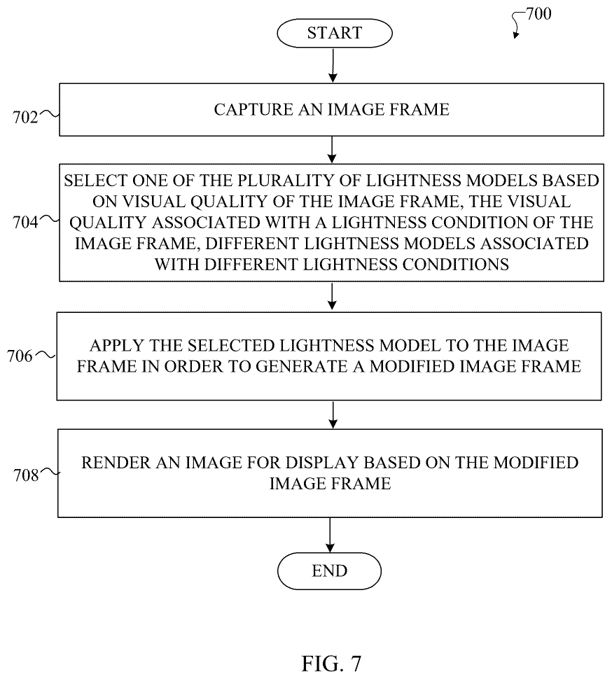

FIG. 7 illustrates an example method 700 for visual enhancement of a see-through image frame for XR or other applications in accordance with this disclosure. For ease of explanation, the method 700 shown in FIG. 7 is described as being performed using the electronic device 101 in the network configuration 100 shown in FIG. 1, where the electronic device 101 may implement the process 200 shown in FIG. 2. However, the method 700 may be performed using any other suitable device(s) and in any other suitable system(s), and the method 700 may be implemented using any other suitable process(es) or architecture(s) designed in accordance with this disclosure.

As shown in FIG. 7, an image frame is captured at step 702. This may include, for example, the processor 120 of the electronic device 101 obtaining an image frame captured using at least one imaging sensor 180, 501a of the electronic device 101. At step 704, one of the plurality of lightness models is selected based on visual quality of the image frame. This may include, for example, the processor 120 of the electronic device 101 identifying the visual quality associated with a lightness condition of the image frame, and different lightness models may be associated with different lightness conditions. To select a lightness model, the processor 120 of the electronic device 101 may measure an SNR and lightness level of the image frame, determine whether the measured lightness level falls outside a lightness level threshold, and determine whether the measured SNR is greater than an SNR threshold. In response to the measured SNR being less than the SNR threshold, the lightness model having parameters matching the measured SNR and measured lightness level of the image frame may be selected. In response to a determination that the measured SNR is greater than the SNR threshold, at least one of a white balance algorithm, a histogram equalization algorithm, an image re-lighting algorithm, or a lightness adjustment algorithm may be selected for application to the image frame.

At step 706, the selected lightness model is applied to the image frame in order to generate a modified image frame. This may include, for example, the processor 120 of the electronic device 101 applying a lightness model retrieved from the plurality of the lightness models. The resulting enhanced image frame may be used in any suitable manner. For example, a transformation may be performed and the resulting transformed image frame may be rendered at step 708. This may include, for example, the processor 120 of the electronic device 101 applying a passthrough transformation or other transformation.

Note that, in some cases, the method 700 can be expanded to include the generation of the lightness models. For example, generating the lightness models may include determining one or more thresholds to define the different lightness conditions. For each of the defined lightness conditions, multiple image frames at the defined lightness condition may be captured, a dataset for the defined lightness condition may be created based on the multiple image frames captured at the defined lightness condition, and a lightness model may be generated for the defined lightness condition with one or more parameters based on the dataset.

Although FIG. 7 illustrates one example of a method 700 for image visual enhancement for XR or other applications, various changes may be made to FIG. 7. For example, while shown as a series of steps, various steps in FIG. 7 may overlap, occur in parallel, occur in a different order, or occur any number of times (including zero times). Also, while the method 700 is described as processing an image frame, the method 700 may be duplicated or repeatedly used in order to process one or more sequences of image frames, such as a sequence of image frames from each of left and right see-through cameras or other stereo imaging sensors 180.

It should be noted that the functions shown in or described with respect to FIGS. 2 through 7 can be implemented in an electronic device 101, 102, 104, server 106, or other device(s) in any suitable manner. For example, in some embodiments, at least some of the functions shown in or described with respect to FIGS. 2 through 7 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 7 can be implemented or supported using dedicated hardware components. In general, the functions shown in or described with respect to FIGS. 2 through 7 can be performed using any suitable hardware or any suitable combination of hardware and software/firmware instructions. Also, the functions shown in or described with respect to FIGS. 2 through 7 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. An apparatus comprising:
at least one imaging sensor configured to capture an image frame; and
at least one processing device configured to:
select one of a plurality of lightness models based on visual quality of the image frame, the visual quality associated with a lightness condition of the image frame, different lightness models associated with different lightness conditions;
apply the selected lightness model to the image frame in order to generate a modified image frame; and
render an image for display based on the modified image frame.

2. The apparatus of claim 1, wherein:
the at least one processing device is further configured to generate the lightness models; and
to generate the lightness models, the at least one processing device is configured to:
determine one or more thresholds to define the different lightness conditions; and
for each of the defined lightness conditions:
capture multiple image frames at the defined lightness condition;
create a dataset for the defined lightness condition based on the multiple image frames captured at the defined lightness condition; and
generate the lightness model for the defined lightness condition with one or more parameters based on the dataset.

3. The apparatus of claim 1, wherein, to select one of the plurality of lightness models, the at least one processing device is configured to:
measure a signal-to-noise ratio (SNR) and lightness level of the image frame;
determine whether the measured lightness level falls outside a lightness level threshold;
determine whether the measured SNR is greater than an SNR threshold; and
in response to the measured SNR being less than the SNR threshold, select the lightness model having parameters matching the measured SNR and measured lightness level of the image frame.

4. The apparatus of claim 3, wherein the at least one processing device is further configured to:
in response to a determination that the measured SNR is greater than the SNR threshold, select at least one of a white balance algorithm, a histogram equalization algorithm, an image re-lighting algorithm, or a lightness adjustment algorithm for application to the image frame.

5. The apparatus of claim 1, wherein:
the at least one processing device is further configured to apply a transformation to the modified image frame in order to generate a transformed image frame; and
to render the image for display, the at least one processing device is configured to render the transformed image frame.

6. The apparatus of claim 1, wherein the at least one processing device is further configured to:
generate a dataset using the image frame; and
update a specified one of the lightness models using the dataset; and
wherein the at least one processing device is configured to apply the updated specified lightness model to the image frame in order to generate the modified image frame.

7. The apparatus of claim 1, wherein:
the image frame comprises a first image frame;
the at least one imaging sensor is configured to capture a second image frame sequentially with the first image frame; and
the at least one processing device is further configured to:
obtain a difference between user head poses associated with the first and second image frames;
determine whether the difference is greater than a head pose change threshold;
in response to a determination that the difference is not greater than the head pose change threshold, determine whether visual quality of the second image frame falls outside one or more thresholds utilizing a signal-to-noise ratio (SNR) and lightness level of the first image frame; and
in response to a determination that the difference is greater than the head pose change threshold, determine whether the visual quality of the second image frame falls outside the one or more thresholds utilizing an SNR and lightness level of the second image frame.

8. A method comprising:
obtaining an image frame;
selecting one of a plurality of lightness models based on visual quality of the image frame, the visual quality associated with a lightness condition of the image frame, different lightness models associated with different lightness conditions;
applying the selected lightness model to the image frame in order to generate a modified image frame; and
rendering an image for display based on the modified image frame.

9. The method of claim 8, further comprising:
generating the lightness models by:
determining one or more thresholds to define the different lightness conditions; and
for each of the defined lightness conditions:
capturing multiple image frames at the defined lightness condition;
creating a dataset for the defined lightness condition based on the multiple image frames captured at the defined lightness condition; and
generating the lightness model for the defined lightness condition with one or more parameters based on the dataset.

10. The method of claim 8, wherein selecting one of the plurality of lightness models comprises:
measuring a signal-to-noise ratio (SNR) and lightness level of the image frame;
determining whether the measured lightness level falls outside a lightness level threshold;
determining whether the measured SNR is greater than an SNR threshold; and
in response to the measured SNR being less than the SNR threshold, selecting the lightness model having parameters matching the measured SNR and measured lightness level of the image frame.

11. The method of claim 10, further comprising:
in response to a determination that the measured SNR is greater than the SNR threshold, selecting at least one of a white balance algorithm, a histogram equalization algorithm, an image re-lighting algorithm, or a lightness adjustment algorithm for application to the image frame.

12. The method of claim 8, further comprising:
applying a transformation to the modified image frame in order to generate a transformed image frame;
wherein rendering the image for display comprises rendering the transformed image frame.

13. The method of claim 8, further comprising:
generating a dataset using the image frame; and
updating a specified one of the lightness models using the dataset;
wherein the updated specified lightness model is applied to the image frame in order to generate the modified image frame.

14. The method of claim 8, wherein:
the image frame comprises a first image frame; and
the method further comprises:
capturing a second image frame sequentially with the first image frame;
obtaining a difference between user head poses associated with the first and second image frames;
determining whether the difference is greater than a head pose change threshold;
in response to a determination that the difference is not greater than the head pose change threshold, determining whether visual quality of the second image frame falls outside one or more thresholds utilizing a signal-to-noise ratio (SNR) and lightness level of the first image frame; and
in response to a determination that the difference is greater than the head pose change threshold, determining whether the visual quality of the second image frame falls outside the one or more thresholds utilizing an SNR and lightness level of the second image frame.

15. A non-transitory machine readable medium containing instructions that when executed cause at least one processor of an electronic device to:
obtain an image frame;
select one of a plurality of lightness models based on visual quality of the image frame, the visual quality associated with a lightness condition of the image frame, different lightness models associated with different lightness conditions;
apply the selected lightness model to the image frame in order to generate a modified image frame; and
render an image for display based on the modified image frame.

16. The non-transitory machine readable medium of claim 15, further containing instructions that when executed cause the at least one processor to generate the lightness models;
wherein the instructions that when executed cause the at least one processor to generate the lightness models comprise instructions that when executed cause the at least one processor to:
determine one or more thresholds to define the different lightness conditions; and
for each of the defined lightness conditions:
capture multiple image frames at the defined lightness condition;
create a dataset for the defined lightness condition based on the multiple image frames captured at the defined lightness condition; and
generate the lightness model for the defined lightness condition with one or more parameters based on the dataset.

17. The non-transitory machine readable medium of claim 15, wherein the instructions that when executed cause the at least one processor to select one of the plurality of lightness models comprise instructions that when executed cause the at least one processor to:
measure a signal-to-noise ratio (SNR) and lightness level of the image frame;
determine whether the measured lightness level falls outside a lightness level threshold;
determine whether the measured SNR is greater than an SNR threshold; and
in response to the measured SNR being less than the SNR threshold, select the lightness model having parameters matching the measured SNR and measured lightness level of the image frame.

18. The non-transitory machine readable medium of claim 17, further containing instructions that when executed cause the at least one processor, in response to a determination that the measured SNR is greater than the SNR threshold, to select at least one of a white balance algorithm, a histogram equalization algorithm, an image re-lighting algorithm, or a lightness adjustment algorithm for application to the image frame.

19. The non-transitory machine readable medium of claim 15, further containing instructions that when executed cause the at least one processor to apply a transformation to the modified image frame in order to generate a transformed image frame.

20. The non-transitory machine readable medium of claim 15, further containing instructions that when executed cause the at least one processor to:
generate a dataset using the image frame; and
update a specified one of the lightness models using the dataset.
